(19) United States
(12) Patent Application Publication
(10) Pub. No.: US 2026/0017324 A1
(43) Pub. Date: Jan. 15, 2026

(54) TELEMETRY DATA FILTERING AND ROUTING USING EXPRESSION LANGUAGE REPRESENTATION OF FILTER PREDICATES

(71) Applicant: Snowflake Inc., Bozeman, MT (US)

(72) Inventors: Xiaodi Ke, Markham (CA); Steven Parkes, Palo Alto, CA (US); Jan Michael Timmerman, Guelph (CA); Xie Xu, Seattle, WA (US)

(21) Appl. No.: 18/773,446

(22) Filed: Jul. 15, 2024

(51) Int. Cl. G06F 16/9035

(52) U.S. Cl. CPC G06F 16/9035

(57) ABSTRACT

Disclosed are techniques for routing and filtering telemetry data based on custom telemetry definitions provided by a user. A telemetry filter definition comprising rules for routing and filtering telemetry data may be converted into a common expression language (CEL) abstract syntax tree (AST). The CEL AST may be provided to a filtering component, which may compile the CEL AST into a CEL filter program comprising the rules for routing and filtering telemetry data. In response to receiving telemetry data, filtering, by the filtering component, the received telemetry data based on the CEL filter program to generate filtered telemetry data.

### TECHNICAL FIELD

The present disclosure relates to processing telemetry data in data sharing platforms, and particularly to techniques for filtering/routing telemetry data based on custom telemetry filter definitions provided by a user.

### BACKGROUND

Databases are widely used for data storage and access in computing applications. Databases may include one or more tables that include or reference data that can be read, modified, or deleted using queries. Databases may be used for storing and/or accessing personal information or other sensitive information. Secure storage and access of database data may be provided by encrypting and/or storing data in an encrypted form to prevent unauthorized access. In some cases, data sharing may be desirable to let other parties perform queries against a set of data.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1A is a block diagram depicting an example computing environment in which the methods disclosed herein may be implemented, in accordance with some embodiments of the present invention.

FIG. 1B is a block diagram illustrating an example virtual warehouse, in accordance with some embodiments of the present invention.

FIG. 2 is a schematic block diagram of data that may be used to implement a data sharing platform, in accordance with some embodiments of the present invention.

FIG. 3 is a schematic block diagram of deployment of a data sharing platform that illustrates consumer and provider managed data access techniques, in accordance with some embodiments of the present invention.

FIG. 4A is a block diagram of a deployment of a data sharing platform, illustrating application sharing techniques, in accordance with some embodiments of the present invention.

FIG. 4B is a block diagram illustrating a high-level view of a telemetry routing and filtering system, in accordance with some embodiments of the present invention.

FIG. 4C is a diagram illustrating an example telemetry filter definition, in accordance with some embodiments of the present invention.

FIG. 5A is a block diagram of a deployment of a data sharing platform, implementing techniques for transpiling a user-defined telemetry filter definition into a common expression language (CEL) representation, in accordance with some embodiments of the present invention.

FIG. 5B illustrates a mapping table of SQL AST nodes into corresponding CEL text, in accordance with some embodiments of the present invention.

FIG. 5C illustrates examples of mapping SQL AST nodes into corresponding CEL text using the mapping table of FIG. 5B, in accordance with some embodiments of the present invention.

FIG. 6 is a block diagram of the telemetry routing and filtering system of FIG. 4B performing filtering based on a CEL program at different points during the process of receiving and flattening telemetry data based on the depth of evaluation, in accordance with some embodiments of the present invention.

FIG. 7 is a flow diagram of an example method for filtering/routing telemetry data based on telemetry filter definitions provided by a user, in accordance with some embodiments of the present invention.

FIG. 8 is a block diagram of an example computing device that may perform one or more of the operations described herein, in accordance with some embodiments of the present invention.

### DETAILED DESCRIPTION

Data providers often have data assets that are cumbersome to share. A data asset may be data that is of interest to another entity. For example, a large online retail company may have a data set that includes the purchasing habits of millions of consumers over the last ten years. This data set may be large. If the online retailer wishes to share all or a portion of this data with another entity, the online retailer may need to use old and slow methods to transfer the data, such as a file-transfer-protocol (FTP), or even copying the data onto physical media and mailing the physical media to the other entity. This has several disadvantages. First, it is slow as copying terabytes or petabytes of data can take days. Second, once the data is delivered, the provider cannot control what happens to the data. The recipient can alter the data, make copies, or share it with other parties. Third, the only entities that would be interested in accessing such a large data set in such a manner are large corporations that can afford the complex logistics of transferring and processing the data as well as the high price of such a cumbersome data transfer. Thus, smaller entities (e.g., “mom and pop” shops) or even smaller, more nimble cloud-focused startups are often priced out of accessing this data, even though the data may be valuable to their businesses. This may be because raw data assets are generally too unpolished and full of potentially sensitive data to simply outright sell/provide to other companies. Data cleaning, de-identification, aggregation, joining, and other forms of data enrichment need to be performed by the owner of data before it is shareable with another party. This is time-consuming and expensive. Finally, it is difficult to share data assets with many entities because traditional data sharing methods do not allow scalable sharing for the reasons mentioned above. Traditional sharing methods also introduce latency and delays in terms of all parties having access to the most recently-updated data.

Data sharing platforms such as private and public data exchanges may allow data providers to more easily and securely share their data assets with other entities. A public data exchange (also referred to herein as a “Snowflake data marketplace,” or a “data marketplace”) may provide a centralized repository with open access where a data provider may publish and control live and read-only data sets to thousands of consumers. A private data exchange (also referred to herein as a “data exchange”) may be under the data provider's brand, and the data provider may control who can gain access to it. The data exchange may be for internal use only, or may also be opened to consumers, partners, suppliers, or others. The data provider may control what data assets are listed as well as control who has access to which sets of data. This allows for a seamless way to discover and share data both within a data provider's organization and with its business partners.

The data exchange may be facilitated by a cloud computing service such as the SNOWFLAKE™ cloud computing service, and allows data providers to offer data assets directly from their own online domain (e.g., website) in a private online marketplace with their own branding. The data exchange may provide a centralized, managed hub for an entity to list internally or externally-shared data assets, inspire data collaboration, and also to maintain data governance and to audit access. With the data exchange, data providers may be able to share data without copying it between companies. Data providers may invite other entities to view their data listings, control which data listings appear in their private online marketplace, control who can access data listings and how others can interact with the data assets connected to the listings. This may be thought of as a “walled garden” marketplace, in which visitors to the garden must be approved and access to certain listings may be limited.

As an example, Company A may be a consumer data company that has collected and analyzed the consumption habits of millions of individuals in several different categories. Their data sets may include data in the following categories: online shopping, video streaming, electricity consumption, automobile usage, internet usage, clothing purchases, mobile application purchases, club memberships, and online subscription services. Company A may desire to offer these data sets (or subsets or derived products of these data sets) to other entities. For example, a new clothing brand may wish to access data sets related to consumer clothing purchases and online shopping habits. Company A may support a page on its website that is or functions substantially similar to a data exchange, where a data consumer (e.g., the new clothing brand) may browse, explore, discover, access and potentially purchase data sets directly from Company A. Further, Company A may control: who can enter the data exchange, the entities that may view a particular listing, the actions that an entity may take with respect to a listing (e.g., view only), and any other suitable action. In addition, a data provider may combine its own data with other data sets from, e.g., a public data exchange (also referred to as a “data marketplace”), and create new listings using the combined data.

A data exchange may be an appropriate place to discover, assemble, clean, and enrich data to make it more monetizable. A large company on a data exchange may assemble data from across its divisions and departments, which could become valuable to another company. In addition, participants in a private ecosystem data exchange may work together to join their datasets together to jointly create a useful data product that any one of them alone would not be able to produce. Once these joined datasets are created, they may be listed on the data exchange or on the data marketplace.

Sharing data may be performed when a data provider creates a share object (hereinafter referred to as a share) of a database in the data provider's account and grants the share access to particular objects (e.g., tables, secure views, and secure user-defined functions (UDFs)) of the database. Then, a read-only database may be created using information provided in the share. Access to this database may be controlled by the data provider. A “share” encapsulates all of the information required to share data in a database. A share may include at least three pieces of information: (1) privileges that grant access to the database(s) and the schema containing the objects to share, (2) the privileges that grant access to the specific objects (e.g., tables, secure views, and secure UDFs), and (3) the consumer accounts with which the database and its objects are shared. The consumer accounts with which the database and its objects are shared may be indicated by a list of references to those consumer accounts contained within the share object. Only those consumer accounts that are specifically listed in the share object may be allowed to look up, access, and/or import from this share object. By modifying the list of references of other consumer accounts, the share object can be made accessible to more accounts or be restricted to fewer accounts.

In some embodiments, each share object contains a single role. Grants between this role and objects define what objects are being shared and with what privileges these objects are shared. The role and grants may be similar to any other role and grant system in the implementation of role-based access control. By modifying the set of grants attached to the role in a share object, more objects may be shared (by adding grants to the role), fewer objects may be shared (by revoking grants from the role), or objects may be shared with different privileges (by changing the type of grant, for example to allow write access to a shared table object that was previously read-only). In some embodiments, share objects in a provider account may be imported into the target consumer account using alias objects and cross-account role grants.

When data is shared, no data is copied or transferred between users. Sharing is accomplished through the cloud computing services of a cloud computing service provider such as SNOWFLAKE™. Shared data may then be used to process SQL queries, possibly including joins, aggregations, or other analysis. In some instances, a data provider may define a share such that “secure joins” are permitted to be performed with respect to the shared data. A secure join may be performed such that analysis may be performed with respect to shared data but the actual shared data is not accessible by the data consumer (e.g., recipient of the share).

A data exchange may also implement role-based access control to govern access to objects within consumer accounts using account level roles and grants. In one embodiment, account level roles are special objects in a consumer account that are assigned to users. Grants between these account level roles and database objects define what privileges the account level role has on these objects. For example, a role that has a usage grant on a database can “see” this database when executing the command “show databases”; a role that has a select grant on a table can read from this table but not write to the table. The role would need to have a modify grant on the table to be able to write to it.

Because consumers of data often require the ability to perform various functions on data that has been shared with them, a data exchange may enable users of a data marketplace to build native applications that can be shared with other users of the data marketplace. The native applications can be published and discovered in the data marketplace like any other data listing, and consumers can install them in their local data marketplace account to serve their data processing needs. This helps to bring data processing services and capabilities to consumers instead of requiring a consumer to share data with e.g., a service provider who can perform these data processing services and share the processed data back to the consumer. Stated differently, instead of a consumer having to share potentially sensitive data with a third party who can perform the necessary data processing services and send the results back to the consumer, the desired data processing functionality may be encapsulated, and then shared with the consumer so that the consumer does not have to share their potentially sensitive data.

Monitoring native applications running in consumer accounts is important both for providers and consumers. Event sharing between native application providers and consumers is crucial for observability, troubleshooting, and transparent data governance. Providers want to support their applications running in consumer accounts by having access to events generated by their applications. Events may include for example errors and warnings, metrics, usage logs, debug logs, and query audit logs. These events can help a provider understand how consumers use their shared applications. In addition, when a provider shares an application (e.g., by creating a listing for it in the data exchange), they may include usage metrics in the metadata of the listing so that consumers will have visibility into the resources consumed by the application and can set quotas to adequately budget for the required resource consumption. For example, the provider may provide an indication of the resources (e.g., compute, storage resources) required to run the application in the listing metadata and any consumers interested in the application may set their respective quotas accordingly.

As data sharing platforms grow in size and scale, there is an increasing number of different telemetry data paths/destinations and different telemetry data filtering requirements. Existing telemetry filtering/routing solutions are not flexible enough to support a wide variety of data paths and a wide variety of custom filtering needs. Current data sharing platforms implement logic that only supports fixed filtering/routing operations that are defined by e.g., an operator of the data sharing platform. For example, data sharing platforms may implement custom logic in (e.g., Java and C++) that implements individual telemetry filtering use cases but does not provide a general solution that can implement a custom defined telemetry filtering scheme that is outside one of the individual filtering use cases. As a result, a user of such data sharing platforms is unable to express their specific needs and must rely on whatever fixed operations are offered by the operator of the data sharing platform.

Existing telemetry filtering/routing solutions also do not allow for optimization of filtering solutions (e.g., by reducing computational complexity). For example, SQL defined filter predicates cannot be applied to raw telemetry events directly, and must be evaluated after the events have been ingested into an event table, which requires reuse of the SQL parser and execution engine of the data sharing platform. In addition, existing solutions do not provide flexibility in where/when to apply filtering with respect to flattening and other operations, which precludes applying any filtering earlier in the data path to reduce computational complexity.

Embodiments of the present disclosure address the above and other issues by providing techniques for routing and filtering telemetry data based on custom telemetry definitions provided by a user. User-provided telemetry filtering definitions may be transpiled into an expression language such as common expression language (CEL) that can be run by a variety of different components of a data sharing platform. This requires a transformation between languages as well as a transformation between formats. As used herein, transpiling refers to accepting an expression (e.g., filtering definition) in any appropriate language (e.g., SQL) and emitting a corresponding expression in any appropriate expression language such as common expression language (CEL). The CEL expression can then be compiled with standard CEL tools and libraries. In this way, a telemetry data filtering and routing method is provided that is flexible enough to support a wide variety of data paths and a wide variety of custom filtering needs.

As a result, users can define their own telemetry and routing requirements without the risk of such requirements not being supported. The embodiments of the present disclosure provide significantly more flexibility than previous solutions which do not support custom filtering/routing requirements and are limited to supporting fixed filtering/routing operations that are defined by the operator of the data exchange/database. Embodiments of the present disclosure also allow for optimization of the filtering implementation by providing flexibility in when such filtering is to be applied with respect to flattening and other similar operations performed by a filtering component.

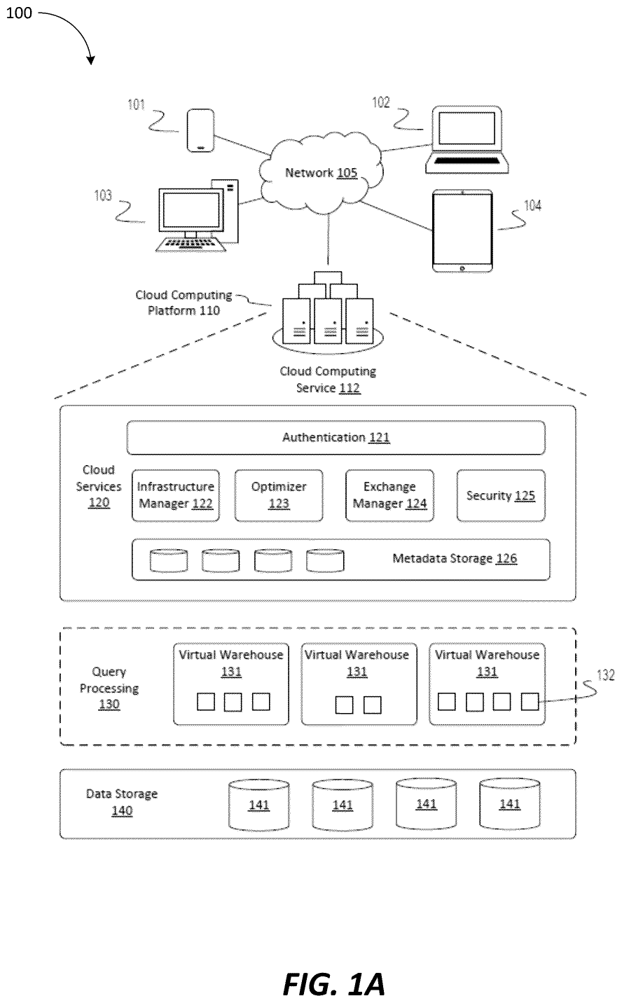

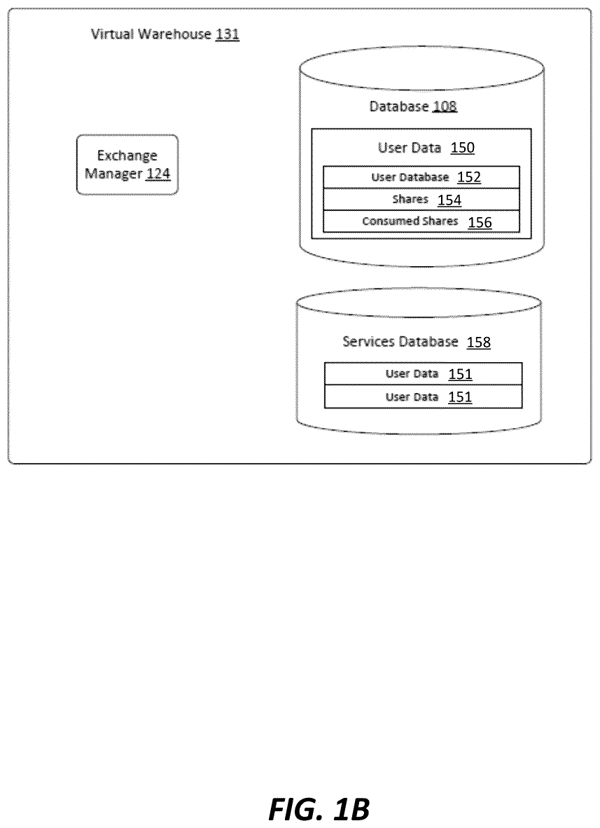

FIG. 1A is a block diagram of an example computing environment 100 in which the systems and methods disclosed herein may be implemented. A cloud computing platform 110 may be implemented, such as Amazon Web Services™ (AWS), Microsoft Azure™, Google Cloud™, or the like. As known in the art, a cloud computing platform 110 provides computing resources and storage resources that may be acquired (purchased) or leased and configured to execute applications and store data.

The cloud computing platform 110 may host a cloud computing service 112 that facilitates storage of data on the cloud computing platform 110 (e.g. data management and access) and analysis functions (e.g. SQL queries, analysis), as well as other computation capabilities (e.g., secure data sharing between users of the cloud computing platform 110). The cloud computing platform 110 may include a three-tier architecture: data storage 140, query processing 130, and cloud services 120.

Data storage 140 may facilitate the storing of data on the cloud computing platform 110 in one or more cloud databases 141. Data storage 140 may use a storage service such as Amazon S3™ to store data and query results on the cloud computing platform 110. In particular embodiments, to load data into the cloud computing platform 110, data tables may be horizontally partitioned into large, immutable files which may be analogous to blocks or pages in a traditional database system. Within each file, the values of each attribute or column are grouped together and compressed using a scheme sometimes referred to as hybrid columnar. Each table has a header which, among other metadata, contains the offsets of each column within the file.

In addition to storing table data, data storage 140 facilitates the storage of temp data generated by query operations (e.g., joins), as well as the data contained in large query results. This may allow the system to compute large queries without out-of-memory or out-of-disk errors. Storing query results this way may simplify query processing as it removes the need for server-side cursors found in traditional database systems.

Query processing 130 may handle query execution within elastic clusters of virtual machines, referred to herein as virtual warehouses or data warehouses. Thus, query processing 130 may include one or more virtual warehouses 131, which may also be referred to herein as data warehouses. The virtual warehouses 131 may be one or more virtual machines operating on the cloud computing platform 110. The virtual warehouses 131 may be compute resources that may be created, destroyed, or resized at any point, on demand. This functionality may create an “elastic” virtual warehouse that expands, contracts, or shuts down according to the user's needs. Expanding a virtual warehouse involves generating one or more compute nodes 132 to a virtual warehouse 131. Contracting a virtual warehouse involves removing one or more compute nodes 132 from a virtual warehouse 131. More compute nodes 132 may lead to faster compute times. For example, a data load which takes fifteen hours on a system with four nodes might take only two hours with thirty-two nodes.

Cloud services 120 may be a collection of services that coordinate activities across the cloud computing service 112. These services tie together all of the different components of the cloud computing service 112 in order to process user requests, from login to query dispatch. Cloud services 120 may operate on compute instances provisioned by the cloud computing service 112 from the cloud computing platform 110. Cloud services 120 may include a collection of services that manage virtual warehouses, queries, transactions, data exchanges, and the metadata associated with such services, such as database schemas, access control information, encryption keys, and usage statistics. Cloud services 120 may include, but not be limited to, authentication engine 121, infrastructure manager 122, optimizer 123, exchange manager 124, security engine 125, and metadata storage 126.

FIG. 1B is a block diagram illustrating an example virtual warehouse 131. The exchange manager 124 may facilitate the sharing of data between data providers and data consumers, using, for example, a data exchange. For example, cloud computing service 112 may manage the storage and access of a database 108. The database 108 may include various instances of user data 150 for different users e.g., different enterprises or individuals. The user data 150 may include a user database 152 of data stored and accessed by that user. The user database 152 may be subject to access controls such that only the owner of the data is allowed to change and access the user database 152 upon authenticating with the cloud computing service 112. For example, data may be encrypted such that it can only be decrypted using decryption information possessed by the owner of the data. Using the exchange manager 124, specific data from a user database 152 that is subject to these access controls may be shared with other users in a controlled manner. In particular, a user may specify shares 154 that may be shared in a public or data exchange in an uncontrolled manner or shared with specific other users in a controlled manner as described above. A “share” encapsulates all of the information required to share data in a database. A share may include at least three pieces of information: (1) privileges that grant access to the database(s) and the schema containing the objects to share, (2) the privileges that grant access to the specific objects (e.g., tables, secure views, and secure UDFs), and (3) the consumer accounts with which the database and its objects are shared. When data is shared, no data is copied or transferred between users. Sharing is accomplished through the cloud services 120 of cloud computing service 112.

Sharing data may be performed when a data provider creates a share of a database in the data provider's account and grants access to particular objects (e.g., tables, secure views, and secure user-defined functions (UDFs)). Then a read-only database may be created using information provided in the share. Access to this database may be controlled by the data provider.

Shared data may then be used to process SQL queries, possibly including joins, aggregations, or other analysis. In some instances, a data provider may define a share such that “secure joins” are permitted to be performed with respect to the shared data. A secure join may be performed such that analysis may be performed with respect to shared data but the actual shared data is not accessible by the data consumer (e.g., recipient of the share). A secure join may be performed as described in U.S. application Ser. No. 16/368,339, filed Mar. 18, 2019.

User devices 101-104, such as laptop computers, desktop computers, mobile phones, tablet computers, cloud-hosted computers, cloud-hosted serverless processes, or other computing processes or devices may be used to access the virtual warehouse 131 or cloud service 120 by way of a network 105, such as the Internet or a private network.

In the description below, actions are ascribed to users, particularly consumers and providers. Such actions shall be understood to be performed with respect to devices 101-104 operated by such users. For example, notification to a user may be understood to be a notification transmitted to devices 101-104, an input or instruction from a user may be understood to be received by way of the user's devices 101-104, and interaction with an interface by a user shall be understood to be interaction with the interface on the user's devices 101-104. In addition, database operations (joining, aggregating, analysis, etc.) ascribed to a user (consumer or provider) shall be understood to include performing of such actions by the cloud computing service 112 in response to an instruction from that user.

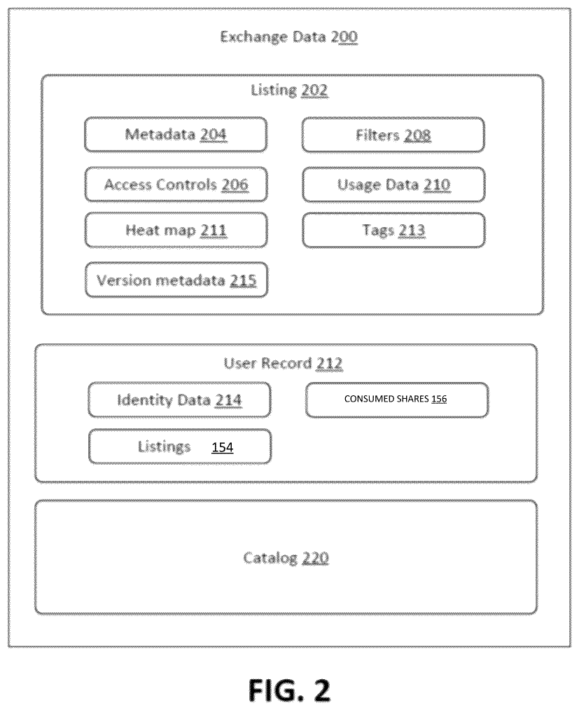

FIG. 2 is a schematic block diagram of data that may be used to implement a public or data exchange in accordance with an embodiment of the present invention. The exchange manager 124 may operate with respect to some or all of the illustrated exchange data 200, which may be stored on the platform executing the exchange manager 124 (e.g., the cloud computing platform 110) or at some other location. The exchange data 200 may include a plurality of listings 202 describing data that is shared by a first user (“the provider”). The listings 202 may be listings in a data exchange or in a data marketplace. The access controls, management, and governance of the listings may be similar for both a data marketplace and a data exchange.

The listing 202 may include access controls 206, which may be configurable to any suitable access configuration. For example, access controls 206 may indicate that the shared data is available to any member of the private exchange without restriction (an “any share” as used elsewhere herein). The access controls 206 may specify a class of users (members of a particular group or organization) that are allowed to access the data and/or see the listing. The access controls 206 may specify that a “point-to-point” share in which users may request access but are only allowed access upon approval of the provider. The access controls 206 may specify a set of user identifiers of users that are excluded from being able to access the data referenced by the listing 202.

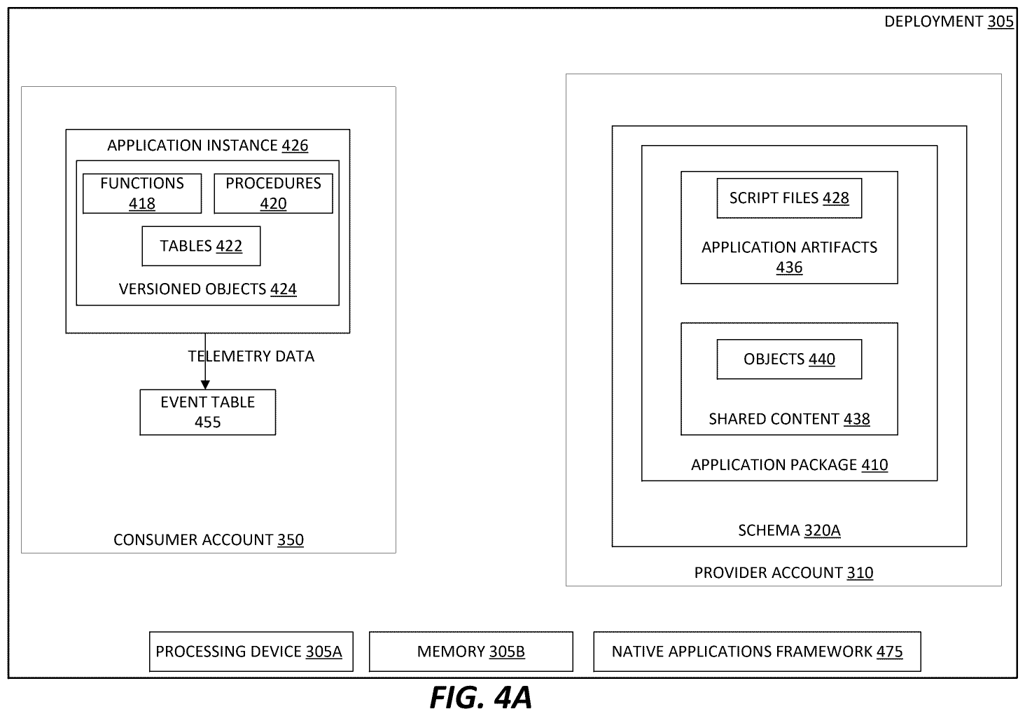

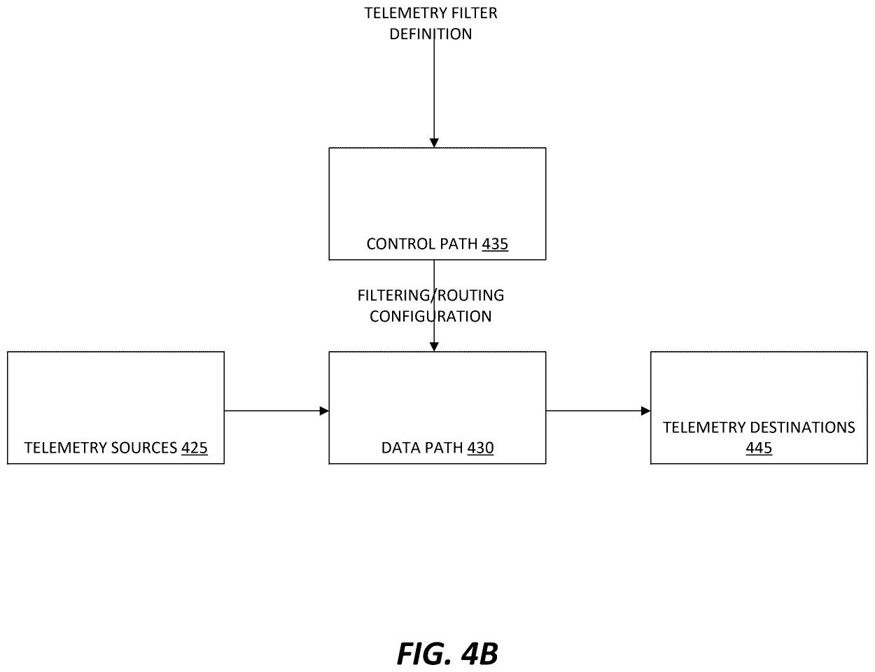

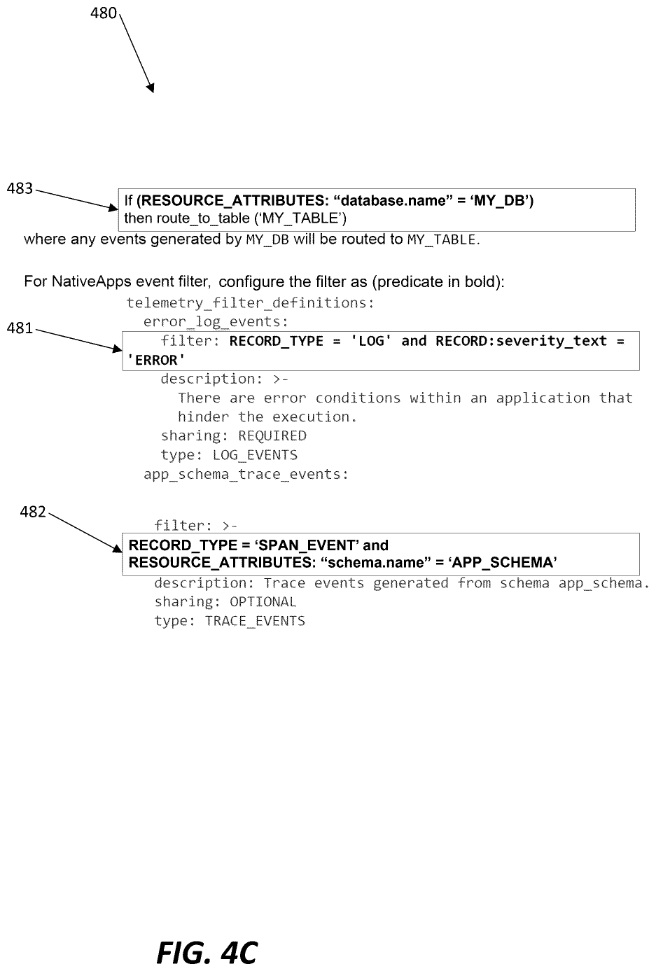

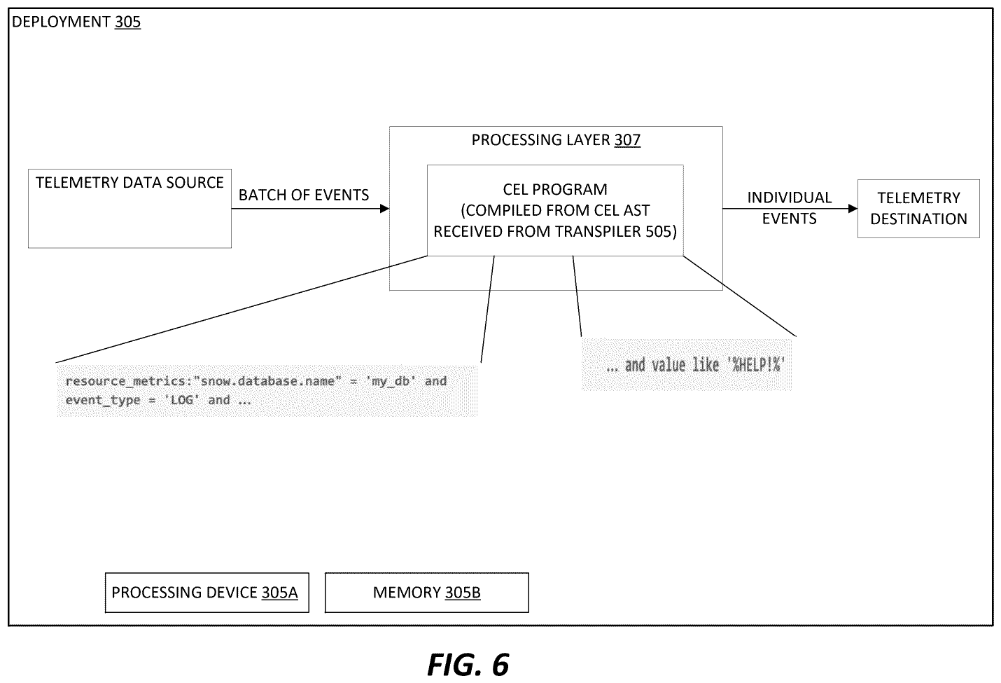

Note that some listings 202 may be discoverable by users without further authentication or access permissions whereas actual accesses are only permitted after a subsequent authentication step (see discussion of FIGS. 4 and 6). The access controls 206 may specify that a listing 202 is only discoverable by specific users or classes of users.

Note also that a default function for listings 202 is that the data referenced by the share is not exportable by the consumer. Alternatively, the access controls 206 may specify that this is not permitted. For example, access controls 206 may specify that secure operations (secure joins and secure functions as discussed below) may be performed with respect to the shared data such that viewing and exporting of the shared data is not permitted.

In some embodiments, once a user is authenticated with respect to a listing 202, a reference to that user (e.g., user identifier of the user's account with the virtual warehouse 131) is added to the access controls 206 such that the user will subsequently be able to access the data referenced by the listing 202 without further authentication.

The listing 202 may define one or more filters 208. For example, the filters 208 may define specific identity data 214 (also referred to herein as user identifiers) of users that may view references to the listing 202 when browsing the catalog 220. The filters 208 may define a class of users (users of a certain profession, users associated with a particular company or organization, users within a particular geographical area or country) that may view references to the listing 202 when browsing the catalog 220. In this manner, a private exchange may be implemented by the exchange manager 124 using the same components. In some embodiments, an excluded user that is excluded from accessing a listing 202 i.e., adding the listing 202 to the consumed shares 156 of the excluded user, may still be permitted to view a representation of the listing when browsing the catalog 220 and may further be permitted to request access to the listing 202 as discussed below. Requests to access a listing by such excluded users and other users may be listed in an interface presented to the provider of the listing 202. The provider of the listing 202 may then view demand for access to the listing and choose to expand the filters 208 to permit access to excluded users or classes of excluded users (e.g., users in excluded geographic regions or countries).

Filters 208 may further define what data may be viewed by a user. In particular, filters 208 may indicate that a user that selects a listing 202 to add to the consumed shares 156 of the user is permitted to access the data referenced by the listing but only a filtered version that only includes data associated with the identity data 214 of that user, associated with that user's organization, or specific to some other classification of the user. In some embodiments, a private exchange is by invitation: users invited by a provider to view listings 202 of a private exchange are enabled to do by the exchange manager 124 upon communicating acceptance of an invitation received from the provider.

In some embodiments, a listing 202 may be addressed to a single user. Accordingly, a reference to the listing 202 may be added to a set of “pending shares” that is viewable by the user. The listing 202 may then be added to a group of shares of the user upon the user communicating approval to the exchange manager 124.

The listing 202 may further include usage data 210. For example, the cloud computing service 112 may implement a credit system in which credits are purchased by a user and are consumed each time a user runs a query, stores data, or uses other services implemented by the cloud computing service 112. Accordingly, usage data 210 may record an amount of credits consumed by accessing the shared data. Usage data 210 may include other data such as a number of queries, a number of aggregations of each type of a plurality of types performed against the shared data, or other usage statistics. In some embodiments, usage data for a listing 202 or multiple listings 202 of a user is provided to the user in the form of a shared database, i.e. a reference to a database including the usage data is added by the exchange manager 124 to the consumed shares 156 of the user.

The listing 202 may also include a heat map 211, which may represent the geographical locations in which users have clicked on that particular listing. The cloud computing service 112 may use the heat map to make replication decisions or other decisions with the listing. For example, a data exchange may display a listing that contains weather data for Georgia, USA. The heat map 211 may indicate that many users in California are selecting the listing to learn more about the weather in Georgia. In view of this information, the cloud computing service 112 may replicate the listing and make it available in a database whose servers are physically located in the western United States, so that consumers in California may have access to the data. In some embodiments, an entity may store its data on servers located in the western United States. A particular listing may be very popular to consumers. The cloud computing service 112 may replicate that data and store it in servers located in the eastern United States, so that consumers in the Midwest and on the East Coast may also have access to that data.

The listing 202 may also include one or more tags 213. The tags 213 may facilitate simpler sharing of data contained in one or more listings. As an example, a large company may have a human resources (HR) listing containing HR data for its internal employees on a data exchange. The HR data may contain ten types of HR data (e.g., employee number, selected health insurance, current retirement plan, job title, etc.). The HR listing may be accessible to 100 people in the company (e.g., everyone in the HR department). Management of the HR department may wish to add an eleventh type of HR data (e.g., an employee stock option plan). Instead of manually adding this to the HR listing and granting each of the 100 people access to this new data, management may simply apply an HR tag to the new data set and that can be used to categorize the data as HR data, list it along with the HR listing, and grant access to the 100 people to view the new data set.

The listing 202 may also include version metadata 215. Version metadata 215 may provide a way to track how the datasets are changed. This may assist in ensuring that the data that is being viewed by one entity is not changed prematurely. For example, if a company has an original data set and then releases an updated version of that data set, the updates could interfere with another user's processing of that data set, because the update could have different formatting, new columns, and other changes that may be incompatible with the current processing mechanism of the recipient user. To remedy this, the cloud computing service 112 may track version updates using version metadata 215. The cloud computing service 112 may ensure that each data consumer accesses the same version of the data until they accept an updated version that will not interfere with current processing of the data set.

The exchange data 200 may further include user records 212. The user record 212 may include data identifying the user associated with the user record 212, e.g. an identifier (e.g., warehouse identifier) of a user having user data 151 in service database 158 and managed by the virtual warehouse 131.

The user record 212 may list shares associated with the user, e.g., listings 154 (shares 154) created by the user. The user record 212 may list shares consumed by the user i.e., consumed shares 156 which may be listings 202 created by another user and that have been associated to the account of the user according to the methods described herein. For example, a listing 202 may have an identifier that will be used to reference it in the shares or consumed shares 156 of a user record 212.

The listing 202 may also include metadata 204 describing the shared data. The metadata 204 may include some or all of the following information: an identifier of the provider of the shared data, a URL associated with the provider, a name of the share, a name of tables, a category to which the shared data belongs, an update frequency of the shared data, a catalog of the tables, a number of columns and a number of rows in each table, as well as name for the columns. The metadata 204 may also include examples to aid a user in using the data. Such examples may include sample tables that include a sample of rows and columns of an example table, example queries that may be run against the tables, example views of an example table, example visualizations (e.g., graphs, dashboards) based on a table's data. Other information included in the metadata 204 may be metadata for use by business intelligence tools, text description of data contained in the table, keywords associated with the table to facilitate searching, a link (e.g., URL) to documentation related to the shared data, and a refresh interval indicating how frequently the shared data is updated along with the date the data was last updated.

The metadata 204 may further include category information indicating a type of the data/service (e.g., location, weather), industry information indicating who uses the data/service (e.g., retail, life sciences), and use case information that indicates how the data/service is used (e.g., supply chain optimization, or risk analysis). For instance, retail consumers may use weather data for supply chain optimization. A use case may refer to a problem that a consumer is solving (i.e., an objective of the consumer) such as supply chain optimization. A use case may be specific to a particular industry, or can apply to multiple industries. Any given data listing (i.e., dataset) can help solve one or more use cases, and hence may be applicable to multiple use cases.

The exchange data 200 may further include a catalog 220. The catalog 220 may include a listing of all available listings 202 and may include an index of data from the metadata 204 to facilitate browsing and searching according to the methods described herein. In some embodiments, listings 202 are stored in the catalog in the form of JavaScript Object Notation (JSON) objects.

Note that where there are multiple instances of the virtual warehouse 131 on different cloud computing platforms, the catalog 220 of one instance of the virtual warehouse 131 may store listings or references to listings from other instances on one or more other cloud computing platforms 110. Accordingly, each listing 202 may be globally unique (e.g., be assigned a globally unique identifier across all of the instances of the virtual warehouse 131). For example, the instances of the virtual warehouses 131 may synchronize their copies of the catalog 220 such that each copy indicates the listings 202 available from all instances of the virtual warehouse 131. In some instances, a provider of a listing 202 may specify that it is to be available on only specified one or more computing platforms 110.

In some embodiments, the catalog 220 is made available on the Internet such that it is searchable by a search engine such as the Bing™ search engine or the Google search engine. The catalog may be subject to a search engine optimization (SEO) algorithm to promote its visibility. Potential consumers may therefore browse the catalog 220 from any web browser. The exchange manager 124 may expose uniform resource locators (URLs) linked to each listing 202. This URL may be searchable and can be shared outside of any interface implemented by the exchange manager 124. For example, the provider of a listing 202 may publish the URLs for its listings 202 in order to promote usage of its listing 202 and its brand.

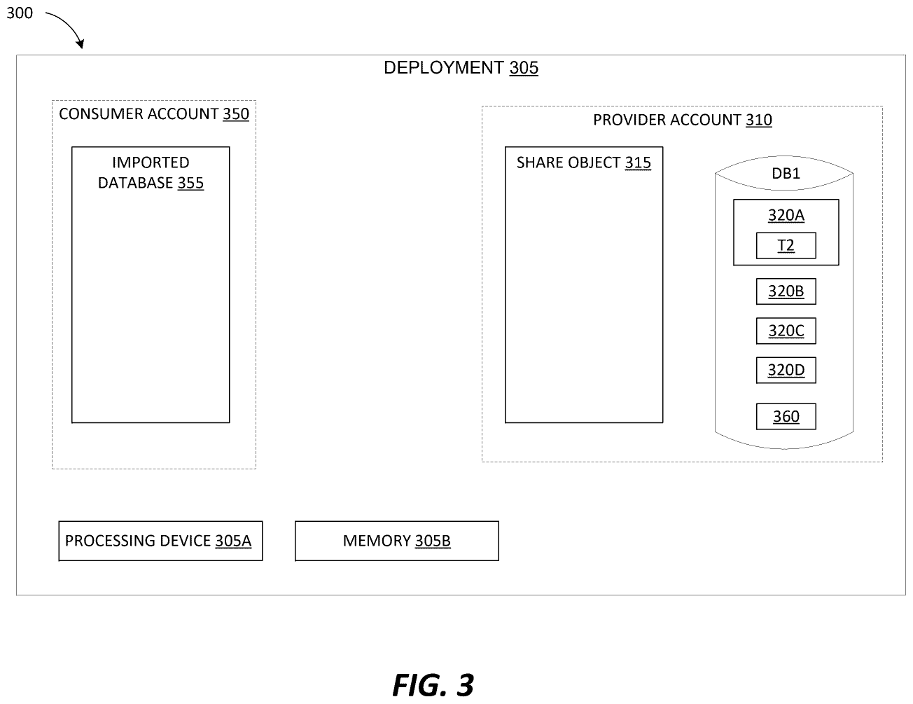

FIG. 3 illustrates a cloud environment 300 comprising a cloud deployment 305, which may comprise a similar architecture to cloud computing service 112 (illustrated in FIG. 1A) and may be a deployment of a data exchange or data marketplace. Although illustrated with a single cloud deployment, the cloud environment 300 may have multiple cloud deployments which may be physically located in separate remote geographical regions but may all be deployments of a single data exchange or data marketplace. Although embodiments of the present disclosure are described with respect to a data exchange, this is for example purpose only and the embodiments of the present disclosure may be implemented in any appropriate enterprise database system or data sharing platform where data may be shared among users of the system/platform.

The cloud deployment 305 may include hardware such as processing device 305A (e.g., processors, central processing units (CPUs), memory 305B (e.g., random access memory (RAM), storage devices (e.g., hard-disk drive (HDD), solid-state drive (SSD), etc.), and other hardware devices (e.g., sound card, video card, etc.). A storage device may comprise a persistent storage that is capable of storing data. A persistent storage may be a local storage unit or a remote storage unit. Persistent storage may be a magnetic storage unit, optical storage unit, solid state storage unit, electronic storage units (main memory), or similar storage unit. Persistent storage may also be a monolithic/single device or a distributed set of devices. The cloud deployment 305 may comprise any suitable type of computing device or machine that has a programmable processor including, for example, server computers, desktop computers, laptop computers, tablet computers, smartphones, set-top boxes, etc. In some examples, the cloud deployment 305 may comprise a single machine or may include multiple interconnected machines (e.g., multiple servers configured in a cluster).

Databases and schemas may be used to organize data stored in the cloud deployment 305 and each database may belong to a single account within the cloud deployment 305. Each database may be thought of as a container having a classic folder hierarchy within it. Each database may be a logical grouping of schemas and a schema may be a logical grouping of database objects (tables, views, etc.). Each schema may belong to a single database. Together, a database and a schema may comprise a namespace. When performing any operations on objects within a database, the namespace is inferred from the current database and the schema that is in use for the session. If a database and schema are not in use for the session, the namespace must be explicitly specified when performing any operations on the objects. As shown in FIG. 3, the cloud deployment 305 may include a provider account 310 including database DB1 having schemas 320A-320D.

FIG. 3 also illustrates share-based access to objects in the provider account 310. The provider account 310 may create a share object 315, which includes grants to database DB1 and schema 320A, as well as a grant to a table T2 located in schema 320A. The grants on database DB1 and schema 320A may be usage grants and the grant on table T2 may be a select grant. In this case, the table T2 in schema 320A in database DB1 would be shared read-only. The share object 315 may contain a list of references (not shown) to various consumer accounts, including the consumer account 350.

After the share object 315 is created, it may be imported or referenced by consumer account 350 (which has been listed in the share object 315). Consumer account 350 may run a command to list all available share objects for importing. Only if the share object 315 was created with a reference to the consumer account 350, then the consumer account 350 reveals the share object using the command to list all share objects and subsequently import it. In one embodiment, references to a share object in another account are always qualified by account name. For example, consumer account 350 would reference a share object SH1 in provider account A1 with the example qualified name “A1.SH1.” Upon the share object 315 being imported to consumer account 350 (shown as imported database 355), an administrator role (e.g., an account level role) of the consumer account 350 may be given a usage grant to the imported database 355. In this way, a user in account 350 with the administrator role 350A may access data from DB1 that is explicitly shared/included in the share object 315.

Similar to the way that data can be shared from a provider account to a consumer account, applications can also be shared from a provider account to a consumer account. As with sharing of data, sharing of a native application (hereinafter referred to as an application) may be performed using a shared container.

FIG. 4A illustrates an example native application sharing process taking place within the deployment 305. It should be noted that embodiments of the present disclosure may be used with any native application sharing process and the process illustrated in FIG. 4A is not limiting. Upon creating the database DB1 and the schema 320A, the provider account 310 may generate an application package 410 and store it in the schema 320A. The provider account 310 may define the application package 410 with the necessary functionality to install the application (including any objects and procedures required by the application) in the consumer account 350. The native applications framework 475 may enable the provider account 310 to indicate that the application package 410 will automatically be invoked with no arguments when a consumer with whom the application package 410 has been shared requests installation of the application. The provider account 310 may create an application share object (not shown) and attach the application package 410 to the application share object. The provider account 310 may then grant the necessary privileges to the application share object including usage on the database DB1, usage on the schema 320A, and usage on the application package 410.

When the consumer account 350 runs a command to see the available listings, they may see a listing corresponding to the application share object and may run a command to create an instance of application 426 from the listing (e.g., CREATE APPLICATION <name> FROM LISTING <listing name>). In response to execution of the command, the native applications framework 475 may automatically trigger execution of script files 428 and other application artifacts 436 of the application package 410, which may create objects (e.g., credentials, API integration, and a warehouse) as well as tasks/procedures corresponding to the functionality of the application instance 426 in the consumer account 350 as discussed in further detail herein. The consumer account 350 may also grant privileges necessary for the application instance 426 to run (some privileges are granted on objects managed and owned by the consumer account 350) including usage on secrets, usage on the API Integration, usage on the warehouse, and privileges granted to the application instance 426 if it needs to access objects of the consumer account 350 or execute procedures in the consumer account 350. Once installed, the application instance 426 may perform various functions in the consumer account 350 as long as the consumer account 350 has authorized it. The application instance 426 can act as an agent, and take any action that any role on the consumer account 350 could take such as e.g., set up a task pipeline, set up data ingestion (e.g., via Snowpipe™ ingestion), or any other defined functionality of the application instance 426. The application instance 426 may act on behalf of the consumer account 350 and execute procedures in a programmatic way.

The application instance 426 comprises a set of versioned objects 424 that are created during the instantiation of the application instance 426. The versioned objects 424 include objects that are defined by the application artifacts 436. In some examples, the versioned objects 424 comprise one or more functions 418, one or more procedures 420, one or more tables 422, and the like.

As shown in FIG. 4A, the application package 410 further comprises shared content 438 comprising one or more data objects, such as objects 440, that constitute objects shared to the application instance 426 that are accessed and/or operated on by the application instance 426 during execution of executable objects of the application instance 426 such as, but not limited to, functions 418 and procedures 420. In some embodiments, the shared content 438 comprises one or more schemas containing objects such as, but not limited to, tables, views, and the like. In some embodiments, the shared content 438 is accessed by the application instance 426 based on a set of security protocols.

As the application instance 426 executes, it may generate telemetry data. The telemetry data generated by the application instance 426 may comprise a plurality of events and may be transmitted to/organized within an event table 455, which includes a row for each event, a first column to indicate a type of each event (e.g., log, metric, span, or span event) and a second column to provide information regarding each event. The information regarding each event may not be stored exclusively in the second column, and the event table may include any appropriate number of columns over which the information regarding each event may be stored. When the first column for an event indicates a log event type, the corresponding entry in the second column may include severity text indicating information about the log event such as the severity of the log event. Example severity text may include Trace, Debug, Info, Warning, Error, and Fatal. Based on the severity text, a log event may be classified as e.g., a usage log, an error log, a debug log, or a query audit log. In addition, the severity text may indicate a scope of the log event such as a class name for the log event. When the event type is span or span event, the second column may include e.g., a name of the span or span event. It should be noted that a span may represent an individual execution of a function or procedure while a span event may be an event record attached to a particular span execution.

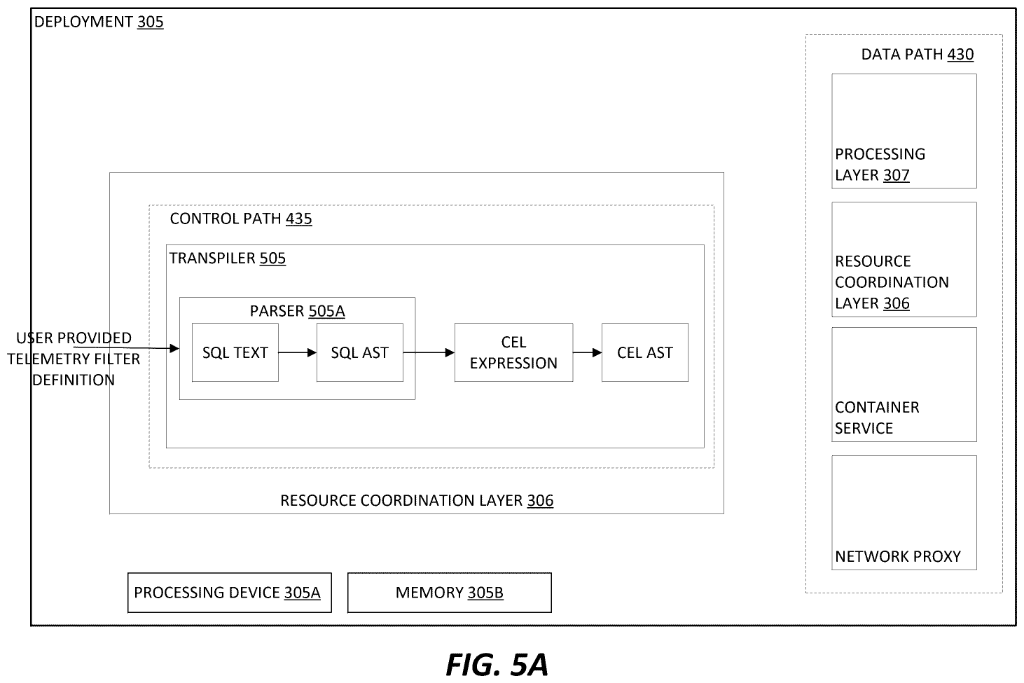

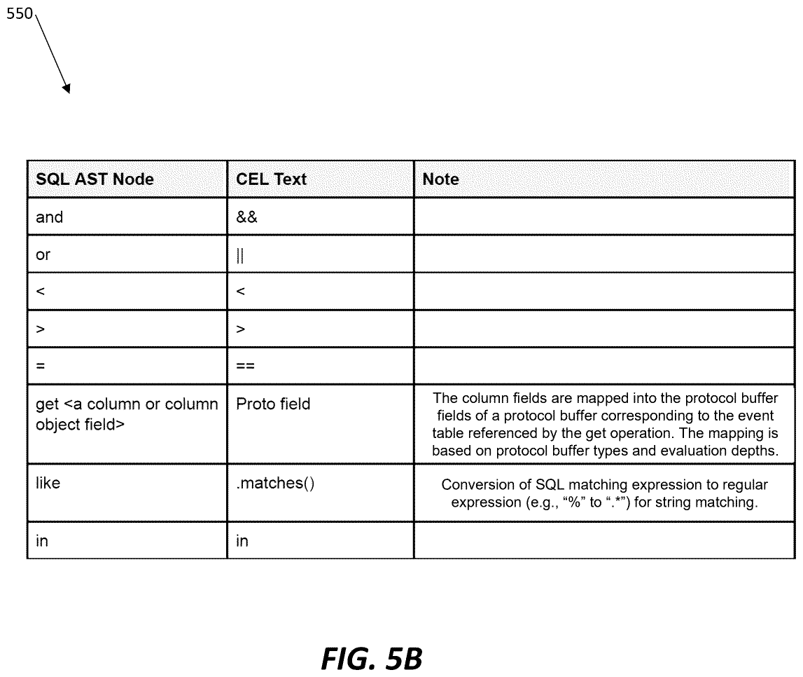

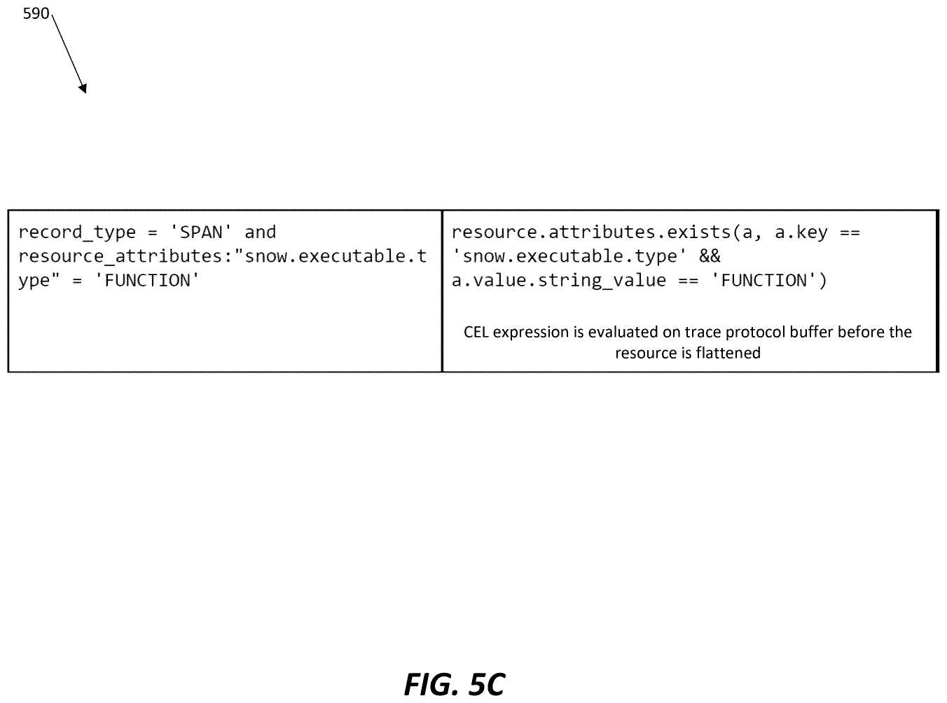

It should be noted that the embodiments of the present disclosure are not limited to telemetry data generated by shared applications and may be applied to telemetry data generated from any appropriate telemetry data source. For example, the deployment 305 may include a processing layer 307 (shown in FIG. 5A), which may perform query execution, filtering and other functions, and may comprise multiple virtual warehouses, each of which is a compute cluster (e.g., a massively parallel processing compute cluster) composed of multiple compute nodes. The processing layer 307 may be a telemetry data source as telemetry data may be generated by the processing layer 307 as a result of query execution or a number of other functions of the processing layer 307. The processing layer 307 may also be a destination for telemetry data as it performs filtering and other functions related to telemetry data. The deployment 305 may further include a resource coordination layer 306 (shown in FIG. 5A), which may be a collection of services that process user requests, including login, metadata management, query parsing/optimization, and query coordination/dispatch services. Similar to the processing layer 307, the resource coordination layer 306 may be a telemetry data source as well as a destination for telemetry data. The resource coordination layer 306 may be divided into two categories: foreground (FG) and background (BG) instances. While FG instances are responsible for handling customer queries (including compilation and query lifecycle management), BG instances are responsible for running a variety of background services including instance health management, updating load balancer configurations, and orchestration tasks themselves. BG instances may be partitioned into dedicated clusters for provisioning services, core background services and compute tasks, etc.

The deployment 305 may use any appropriate protocol to generate, collect, manage, and export telemetry data. For example, the deployment 305 may utilize the OpenTelemetry (OTEL) protocol which defines a telemetry data model (including protocol buffers for telemetry payloads) and a collection protocol. Protocol buffers provide a cross-platform (e.g., language-neutral, platform-neutral) extensible data format used to serialize structured data. Events generated by the application instance 426 (or other appropriate telemetry data source) may be represented as protocol buffers of the OTEL protocol. The OTEL protocol and the protocol buffers may be used by the deployment 305 as a rendering specification. The deployment 305 may also define a rendering of events as rows in an event table e.g., event table 455.

FIG. 4B illustrates a high-level view of the telemetry routing and filtering system described herein. A uniform data path 430 (also referred to herein as data path 430) is provided that accepts raw events (telemetry data) from any of a variety of telemetry data sources including a shared application such as application instance 426, the resource coordination layer 306, the processing layer 307, or even sources external to the deployment 305. The data path 430 may also receive a filtering/routing configuration for transformation and rendering of the raw events into event table rows and/or routing of events to an appropriate destination as discussed in further detail herein. The raw events may be received by the data path 430 as protocol buffers, as discussed herein.

The data path 430 may receive the filtering/routing configuration from a control path 435. The control path 435 may be implemented via the resource coordination layer 306 or a dedicated service. The control path 435 may receive a user-specified telemetry filter definition and translate it into the filtering/routing configuration. The telemetry filter definition may comprise user-defined predicates defining the telemetry filtering/routing requirements. The telemetry filter definition may be defined using any appropriate language, such as SQL. The ability to support SQL is useful in scenarios including e.g., shared application event filtering where the telemetry filter definitions are provided by users (e.g., provider account 310) who are likely familiar with SQL. Another benefit of using SQL is that both consumers and providers can verify telemetry definitions by putting them into an SQL query and running the SQL query against the event table 455. Although the example embodiments herein describe the telemetry filter definition as being defined using SQL, this is for example purposes only and the telemetry filter definition may be defined using any appropriate language.

The control path 435 may transpile the SQL predicates within the telemetry filter definition into any appropriate expression language, such as common expression language (CEL) as used in describing the example embodiments herein. This may result in a CEL representation of the filtering/routing requirements that instruct the data path 430 on how to properly filter events and route events to their telemetry destinations 445 (e.g., an event table, an event table of a shared application or any other appropriate destination). The filtering/routing configuration may comprise the CEL representation of the filtering/routing requirements generated by the control path 435. The use of CEL may simplify the filtering/routing configuration for the data path 430 as CEL is widely used and has well defined semantics for expression evaluation. The CEL library includes language specification, parser, abstract syntax tree (AST), type checker, and evaluation functionalities. In addition, CEL is available in a variety of languages relevant to data processing and sharing (e.g., Java, Python, C++, Golang). Further, CEL is built on top of protocol buffer types, which are natively applied on telemetry events in the OTEL protocol. Thus, applying CEL on OTEL protocol buffers can be done without rendering events to an event table schema, which is important for performance.

The filtering/routing configuration may be published to the data path 430 via any appropriate remote procedure call (RPC) framework such as gRPC. The data path 430 may utilize the filtering/routing configuration to support telemetry event filtering and routing as discussed in further detail herein.

FIG. 4C illustrates an example SQL telemetry filter definition 480 provided by a user (e.g., a provider of the data sharing platform). As shown in FIG. 4C, the telemetry filter definition 480 may specify a first filter 481 applying to telemetry events having an event type of “log” (shown as “RECORD_TYPE=‘LOG’” in FIG. 4C) and severity text of “error” (shown as “RECORD: severity_text=‘ERROR’” in FIG. 4C). Stated differently, the first filter 481 may filter from telemetry data, error logs for consumption by the user. The telemetry filter definition 480 may also specify a second filter 482 applying to telemetry events having a span type (shown as “RECORD_TYPE=‘SPAN_EVENT’”) and that are generated by a schema (a type of resource) called “APP_SCHEMA” (shown as “RESOURCE_ATTRIBUTES: ‘snow.schema.name’=‘APP_SCHEMA’” in FIG. 4C). The telemetry filter definition of FIG. 4C may also specify routing instructions 483, indicating that any telemetry events generated by a database (a type of resource) called “MY_DB” are to be routed to the event table “MY_TABLE.”

It should be noted that FIG. 4C provides an example only and the actual language and syntax used to define a telemetry filter definition may vary. In addition, the example filter predicates of FIG. 4C are defined to indicate telemetry data that a user is searching for/will be preserved and not telemetry data that will be discarded.

FIG. 5A is a detailed block diagram of the functionality of the control path 435 and the data path 430, in accordance with some embodiments of the present disclosure. In the example of FIG. 5A, the control path 435 functionality may be implemented by the resource coordination layer 306, which may implement a transpiler 505 including an SQL parser 505A. The transpiler 505 may receive a user-defined telemetry filter definition (defined in SQL in the example of FIG. 5A) and may parse the SQL text of the telemetry filter definition to generate an SQL abstract syntax tree (AST). The transpiler 505 may transpile each node of the SQL AST into corresponding CEL text, resulting in a CEL expression. To do this, the transpiler 505 may maintain a mapping table 550 (shown in FIG. 5B) of SQL AST nodes into corresponding CEL text. However, SQL “WHERE” clauses can be complex (e.g., involving joins or union of nested SQL statements). In addition, native applications often have relatively basic filtering requirements. For example, common consumer filtering requirements only involve reviewing logs or searching log messages etc. Thus, the transpiler 505 may only transpile a small subset of SQL semantics. Stated differently, the mapping table 550 maintained by the transpiler 505 may map a small subset of SQL AST nodes to corresponding CEL text. The transpiler 505 may report user errors for any SQL elements that it does not yet support.

FIG. 5B illustrates an example of the mapping table 550 that maps each SQL AST node of the SQL AST to corresponding CEL text. As shown in the example of FIG. 5B, each SQL AST node corresponding to a SQL operator (e.g., “and,” “or,” “<,” “>,” “=”) may have corresponding CEL text (e.g., “&&,” “∥,” “<,” “>,” “==” respectively). An SQL AST node corresponding to a “get” operation may reference e.g., columns of an event table, and each column may be mapped to a corresponding field in a protocol buffer corresponding to the event table. Continuing the example of FIG. 5B, an SQL AST node corresponding to the “like” expression is mapped to the “matches( )” CEL expression.

Referring back to FIG. 5A, the transpiler 505 may then parse the CEL text for each SQL AST node into a CEL AST using the appropriate CEL library (e.g., the CEL Java library) and may transmit (using e.g., any appropriate RPC framework such as gRPC) the CEL AST as a protocol buffer to any of a variety of different filtering components within the deployment 305. The CEL representation of the filtering/routing configuration described with respect to FIG. 4B may refer to the CEL AST generated from the user-defined telemetry filter definition as discussed hereinabove. A filtering component may be software and/or logic that receives and filters and/or routes telemetry data as part of its functionality. Examples of filtering components may be the resource coordination layer 306 and the processing layer 307. Still other examples of filtering components may include a container service (e.g., that facilitates the deployment, management, and scaling of containerized applications) or a programmable network proxy (such as Envoy™). Because CEL supports multiple languages, each filtering component can compile the CEL AST into a CEL program using their respective CEL language specific libraries. Each filtering component may apply the CEL program to a stream of events generated by any appropriate telemetry data source e.g., a shared application, using their respective CEL language specific libraries. In another example, the processing layer 307 may apply the CEL program to a batch of events received from a language runtime (e.g., Python/Java UDF server) and generated by a user-defined function (UDF).

FIG. 5C illustrates an example mapping 590 of part of a SQL filter predicate to CEL text. The example 590 illustrates a filter predicate (record_type=‘SPAN’ and resource_attributes:“snow.executable.type”=‘FUNCTION’) that applies to telemetry events having a span type and that are generated by a function. As shown in FIG. 5C, the CEL text corresponding to the “resource attributes” portion of the filter predicate includes “resource.attributes.exists” where “resource” is the protocol buffer corresponding to “resource_attributes,” (i.e., the data structure that will hold/generate the telemetry data) and “attributes” is a subfield of “resource” that corresponds to executable type (“snow.executable.type”). The “exists” component is a condition for determining whether the attributes subfield corresponds to a function executable type. The condition may specify “a, a.key==‘snow.executable.type’ && a.value.string_value==‘FUNCTION.’”

Telemetry events are often emitted in batches of the same type (e.g., logs, traces, metrics). One batch may contain events generated from multiple resources (i.e., multiple telemetry environment configurations). In turn, events generated by the same resource may have many scopes (such as namespace within the resource) and further, each scope may contain many events. As event batches are generated, they may be sent to any appropriate filtering component (the processing layer 307 in this example) as discussed hereinabove, which may process the batch of events, filter the batch of events and store the filtered batch of events in the event table 455. As part of the processing, the processing layer 307 may perform a flattening process to flatten resource, scope, and event information so each row of the event table 455 contains resource, scope and event values. This allows for a single SQL predicate to be applied to a mixture of resources, scopes and events. For example, a “select” statement can be applied according to some values from each of a number of columns of the event table 455 including the resource attributes column, the scope attributes column and the event value column. However, when transforming SQL predicates into CEL expressions, the transpiler 505 does not have access to this flattened view of the telemetry data, but operates on the telemetry data in its original hierarchical structure.

Thus, for better performance the processing layer 307 needs to apply filtering based on the CEL program at different points during the process of receiving and flattening telemetry data, based on the type of filtering specified by the CEL program (e.g., resource level filtering, event value level filtering), also referred to herein as the depth of evaluation. Therefore, before the processing layer 307 can apply a CEL program to received telemetry data, it first needs to determine the depth of evaluation required by the CEL program.

FIG. 6 illustrates implementation of filtering based on a CEL program at different points during the process of receiving and flattening telemetry data based on the depth of evaluation. As discussed hereinabove, a telemetry data source (a language runtime in this example) may generate a batch of events. Upon generation of the batch of events, the language runtime may transmit the batch of events to the processing layer 307, at which point the processing layer 307 may have the resource information and event type information for the batch of events. Thus, if the CEL program indicates filtering the batch of events based on the resource information and/or based on the event type (e.g., log), the processing layer 307 may apply the filtering (based on the CEL program) to the batch of events before flattening the batch of events and storing it in the event table 455. As shown in FIG. 6, the CEL program indicates filtering based on resource metrics (resource_metrics: “snow.database.name”=‘my_db’) and event type (event_type=‘LOG). Thus, in the example of FIG. 6, the processing layer 307 may apply the resource and event type filtering before flattening the batch of events. The processing layer 307 may then flatten the batch of events (already filtered based on resource metrics and event type as discussed hereinabove). However, because the batch of events has already been filtered based on resource metrics and event type, the amount of telemetry data that must be flattened has now been reduced. This is important because flattening is a computationally expensive operation, and avoiding unnecessary flattening of telemetry data enables the processing layer 307 to be more computationally efficient.

Once the processing layer 307 has performed the flattening operation, the scope and event information for each event in the batch of events may now be available. As shown in FIG. 6, the CEL program further indicates filtering based on event value (and value like ‘% Help!%’). Thus, after performing the flattening operation, the processing layer 307 can apply the event value based filtering as specified in the CEL program to the batch of events (already filtered based on resource metrics and event type as discussed hereinabove) to generate a flattened and filtered (now by resource metrics, event type and event value) batch of events. The processing layer 307 may route individual events from the flattened and filtered batch of events to their appropriate telemetry destination as indicated by the CEL program (e.g., the event table 455).

As shown by the example of FIG. 6, when a user only wishes to perform filtering at a level for which the processing layer 307 will have the appropriate information upon receipt of the telemetry data, the processing layer 307 can perform such filtering immediately after receiving the telemetry data. However, if the user wants to filter at a level that requires flattening of the telemetry data in order for the processing layer 307 to have the appropriate information, then the processing layer 307 may delay such filtering until after the received telemetry data has been flattened.

As can be seen from the above discussion, embodiments of the present disclosure implement routing and filtering for telemetry data based on custom telemetry definitions provided by a user. By transpiling user-provided telemetry filtering definitions into an expression language such as common expression language (CEL), a telemetry data filtering and routing method is provided that is flexible enough to support a wide variety of data paths and a wide variety of custom filtering needs. As a result, users can define their own telemetry and routing requirements without risk of such requirements not being supported. The embodiments of the present disclosure provide significantly more flexibility than previous solutions which do not support custom filtering/routing requirements and are limited to supporting fixed filtering/routing operations that are defined by the operator of the data exchange/database. Embodiments of the present disclosure also allow for optimization of the filtering implementation by providing flexibility with respect to when such filtering is to be applied with respect to flattening and other similar operations performed by a filtering component.

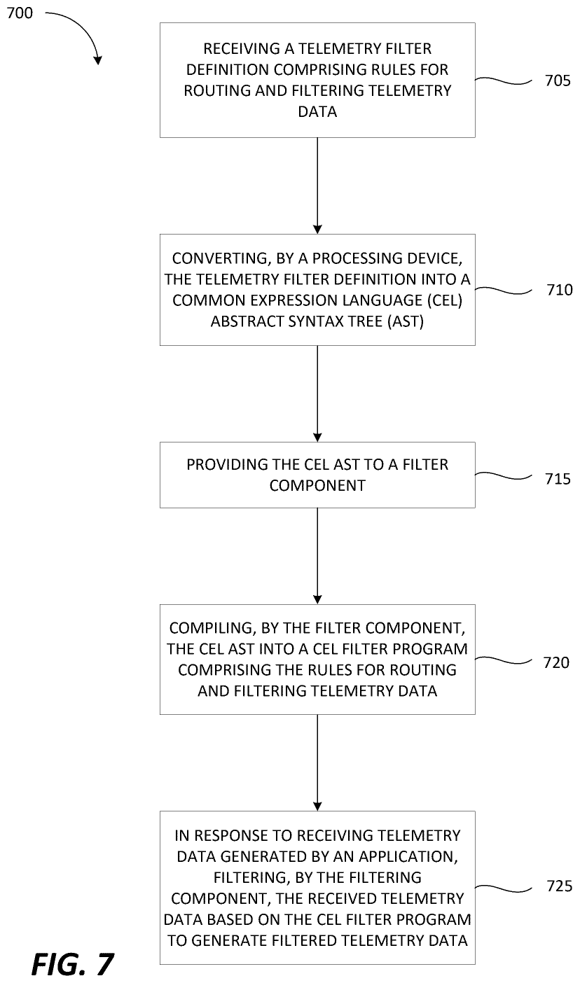

FIG. 7 is a flow diagram of a method 700 for performing routing and/or filtering of telemetry data based on a user-provided telemetry filter definition, in accordance with some embodiments of the present disclosure. Method 700 may be performed by processing logic that may comprise hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some embodiments, the method 700 may be performed by a processing device 305A of deployment 305 (illustrated in FIGS. 4A, 5A and 6).

Referring also to FIG. 5A, at block 705 the transpiler 505 may receive a user-defined telemetry filter definition comprising user-defined predicates defining telemetry filtering/routing requirements. The telemetry filter definitions may be specified in any appropriate language (defined in SQL in the example of FIG. 5A). At block 710, the transpiler 505 may convert the telemetry filter definition into a CEL AST. More specifically, the parser 505A and may parse the SQL text of the telemetry filter definition to generate an SQL abstract syntax tree (AST). The transpiler 505 may transpile each node of the SQL AST into corresponding CEL text, resulting in a CEL expression. To do this, the transpiler 505 may maintain a mapping table 550 (shown in FIG. 5B) of SQL AST nodes into corresponding CEL text. However, SQL “WHERE” clauses can be complex (e.g., involving joins or union of nested SQL statements). In addition, native applications often have relatively basic filtering requirements. For example, common consumer filtering requirements only involve reviewing logs or searching log messages etc. Thus, the transpiler 505 may only transpile a small subset of SQL semantics. Stated differently, the mapping table 550 maintained by the transpiler 505 may map a small subset of SQL AST nodes to corresponding CEL text. The transpiler 505 may report user errors for any SQL elements that it does not yet support. The transpiler 505 may then parse the CEL text for each SQL AST node into a CEL AST using the CEL Java library.

At block 715, the transpiler 505 may transmit (using e.g., any appropriate RPC framework such as gRPC) the CEL AST as a protocol buffer to any of a variety of different filtering components within the deployment 305 (processing layer 307 in the example of FIG. 7). The filtering/routing configuration described with respect to FIG. 4B may refer to the CEL AST generated from the user-defined telemetry filter definition as discussed hereinabove. A filtering component may be software and/or logic that receives and filters and/or routes telemetry data as part of its functionality. Examples of filtering components may be the resource coordination layer 306, and the processing layer 307. Still other examples of filtering components may include a container service designed to facilitate the deployment, management, and scaling of containerized applications or a programmable network proxy (such as Envoy™). Because CEL supports multiple languages, each filtering component can compile the CEL AST into a CEL program using their respective CEL language specific libraries. At block 720, the processing layer 307 may compile the CEL AST into a CEL program using its respective CEL language specific libraries. At block 725, the processing layer 307 may apply the CEL program to a stream of events generated by any appropriate telemetry data source e.g., a native application or a language runtime (e.g., Python/Java UDF server) executing a user-defined function (UDF).

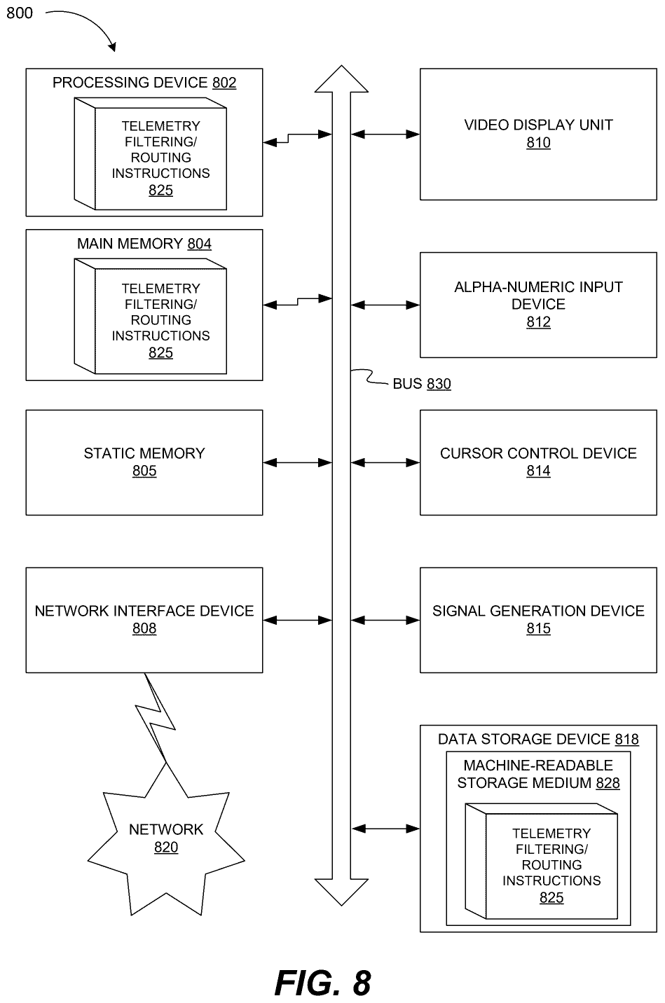

FIG. 8 illustrates a diagrammatic representation of a machine in the example form of a computer system 800 within which a set of instructions is included, the instructions to cause the machine to perform any of the methodologies discussed herein for performing routing and/or filtering of telemetry data based on a user-provided telemetry filter definition.

In alternative embodiments, the machine may be connected (e.g., networked) to other machines in a local area network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, a switch or bridge, a hub, an access point, a network access control device, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. In one embodiment, computer system 800 may be representative of a server.

The exemplary computer system 800 includes a processing device 802, a main memory 804 (e.g., read-only memory (ROM), flash memory, dynamic random access memory (DRAM), a static memory 805 (e.g., flash memory, static random access memory (SRAM), etc.), and a data storage device 818, which communicate with each other via a bus 830. Any of the signals provided over various buses described herein may be time multiplexed with other signals and provided over one or more common buses. Additionally, the interconnection between circuit components or blocks may be shown as buses or as single signal lines. Each of the buses may alternatively be one or more single signal lines and each of the single signal lines may alternatively be buses.

Computing device 800 may further include a network interface device 808 which may communicate with a network 820. The computing device 800 also may include a video display unit 810 (e.g., a liquid crystal display (LCD) or a cathode ray tube (CRT)), an alpha-numeric input device 812 (e.g., a keyboard), a cursor control device 814 (e.g., a mouse) and an acoustic signal generation device 815 (e.g., a speaker). In one embodiment, video display unit 810, alphanumeric input device 812, and cursor control device 814 may be combined into a single component or device (e.g., an LCD touch screen).

Processing device 802 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 802 may also be one or more special-purpose processing devices such as an application specific integrated circuit (ASIC), a field programmable gate array (FPGA), a digital signal processor (DSP), network processor, or the like. The processing device 802 is configured to execute telemetry filtering/routing instructions 825, for performing the operations and steps discussed herein.

The data storage device 818 may include a machine-readable storage medium 828, on which is stored one or more sets of telemetry filtering/routing instructions 825 (e.g., software) embodying any one or more of the methodologies of functions described herein. The telemetry filtering/routing instructions 825 may also reside, completely or at least partially, within the main memory 804 or within the processing device 802 during execution thereof by the computer system 800; the main memory 804 and the processing device 802 also constituting machine-readable storage media. The telemetry filtering/routing instructions 825 may further be transmitted or received over a network 820 via the network interface device 808.

The machine-readable storage medium 828 may also be used to store instructions to perform a method for sharing events generated from a native application being shared by a provider account and executed by a consumer account, as described herein. While the machine-readable storage medium 828 is shown in an exemplary embodiment to be a single medium, the term “machine-readable storage medium” should be taken to include a single medium or multiple media (e.g., a centralized or distributed database, or associated caches and servers) that store the one or more sets of instructions. A machine-readable medium includes any mechanism for storing information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read-only memory (ROM); random-access memory (RAM); erasable programmable memory (e.g., EPROM and EEPROM); flash memory; or another type of medium suitable for storing electronic instructions.

Unless specifically stated otherwise, terms such as “receiving,” “routing,” “granting,” “determining,” “publishing,” “providing,” “designating,” “encoding,” or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may comprise a general purpose computing device selectively programmed by a computer program stored in the computing device. Such a computer program may be stored in a computer-readable non-transitory storage medium.

The methods and illustrative examples described herein are not inherently related to any particular computer or other apparatus. Various general purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. 112, sixth paragraph, for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present disclosure may be written in any combination of one or more programming languages. Such code may be compiled from source code to computer-readable assembly language or machine code suitable for the device or computer on which the code will be executed.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned (including via virtualization) and released with minimal management effort or service provider interaction and then scaled accordingly. A cloud model can be composed of various characteristics (e.g., on-demand self-service, broad network access, resource pooling, rapid elasticity, and measured service), service models (e.g., Software as a Service (“SaaS”), Platform as a Service (“PaaS”), and Infrastructure as a Service (“IaaS”)), and deployment models (e.g., private cloud, community cloud, public cloud, and hybrid cloud).

The flow diagrams and block diagrams in the attached figures illustrate the architecture, functionality, and operation of possible implementations of systems, methods, and computer program products according to various embodiments of the present disclosure. In this regard, each block in the flow diagrams or block diagrams may represent a module, segment, or portion of code, which comprises one or more executable instructions for implementing the specified logical function(s). It will also be noted that each block of the block diagrams or flow diagrams, and combinations of blocks in the block diagrams or flow diagrams, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flow diagram and/or block diagram block or blocks.

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the invention is not to be limited to the details given herein, but may be modified within the scope and equivalents of the appended claims.

What is claimed is:

1. A method comprising:
receiving a telemetry filter definition comprising rules for routing and filtering telemetry data;
converting, by a processing device, the telemetry filter definition into a common expression language (CEL) abstract syntax tree (AST);
providing the CEL AST to a filter component;
compiling, by the filter component, the CEL AST into a CEL filter program comprising the rules for routing and filtering telemetry data; and
in response to receiving telemetry data generated by a telemetry data source, filtering, by the filtering component, the received telemetry data based on the CEL filter program to generate filtered telemetry data.

2. The method of claim 1, wherein converting the telemetry filter definition into the CEL AST comprises:
parsing the telemetry filter definition to generate an AST;
transpiling the AST into CEL text; and
generating, based on the CEL text, the CEL AST.

3. The method of claim 2, wherein the AST comprises a set of AST nodes and the transpiler maintains a mapping of each AST node to corresponding CEL text, and wherein transpiling the AST into the CEL text comprises:
using the mapping to identify the corresponding CEL text for each AST node of the AST.

4. The method of claim 3, wherein the rules for routing and filtering telemetry data comprises rules for filtering telemetry data based on one or more of: resources that generated a plurality of events within the telemetry data, scopes of each of the plurality of events or values of each of the plurality of events.

5. The method of claim 4, wherein filtering the received telemetry data comprises:
determining that the CEL filter program includes a rule for filtering the received telemetry data based on resources that generated a plurality of events within the received telemetry data; and
filtering the received telemetry data using the rule before performing a flattening operation on the received telemetry data.

6. The method of claim 5, wherein filtering the received telemetry data further comprises:
determining that the CEL filter program includes a second rule for filtering the received telemetry data based on scopes of each of the plurality of events within the received telemetry data; and
after performing the flattening operation on the received telemetry data, further filtering the received telemetry data using the second rule to generate the filtered telemetry data.

7. The method of claim 1, further comprising:
routing the filtered telemetry data to one or more destinations based on the CEL filter program.

8. A system comprising:
a memory; and
a processing device operatively coupled to the memory, the processing device to:
receive a telemetry filter definition comprising rules for routing and filtering telemetry data;
convert the telemetry filter definition into a common expression language (CEL) abstract syntax tree (AST);
provide the CEL AST to a filter component;
compile, by the filter component, the CEL AST into a CEL filter program comprising the rules for routing and filtering telemetry data; and
in response to receiving telemetry data generated by a telemetry data source, filter, by the filtering component, the received telemetry data based on the CEL filter program to generate filtered telemetry data.

9. The system of claim 8, wherein to convert the telemetry filter definition into the CEL AST, the processing device is to:
parse the telemetry filter definition to generate an AST;
transpile the AST into CEL text; and
generate, based on the CEL text, the CEL AST.

10. The system of claim 9, wherein the AST comprises a set of AST nodes and the transpiler maintains a mapping of each AST node to corresponding CEL text, and wherein to transpile the AST into the CEL text, the processing device is to:
use the mapping to identify the corresponding CEL text for each AST node of the AST.

11. The system of claim 10, wherein the rules for routing and filtering telemetry data comprises rules for filtering telemetry data based on one or more of: resources that generated a plurality of events within the telemetry data, scopes of each of the plurality of events or values of each of the plurality of events.

12. The system of claim 11, wherein to filter the received telemetry data, the processing device is to:
determine that the CEL filter program includes a rule for filtering the received telemetry data based on resources that generated a plurality of events within the received telemetry data; and
filter the received telemetry data using the rule before performing a flattening operation on the received telemetry data.

13. The system of claim 12, wherein to filter the received telemetry data, the processing device is further to:
determine that the CEL filter program includes a second rule for filtering the received telemetry data based on scopes of each of the plurality of events within the received telemetry data; and
after performing the flattening operation on the received telemetry data, further filter the received telemetry data using the second rule to generate the filtered telemetry data.

14. The system of claim 8, wherein the processing device is further to:
route the filtered telemetry data to one or more destinations based on the CEL filter program.

15. A non-transitory computer-readable medium having instructions stored thereon which, when executed by a processing device, cause the processing device to:
receive a telemetry filter definition comprising rules for routing and filtering telemetry data;
convert, by the processing device, the telemetry filter definition into a common expression language (CEL) abstract syntax tree (AST);
provide the CEL AST to a filter component;
compile, by the filter component, the CEL AST into a CEL filter program comprising the rules for routing and filtering telemetry data; and
in response to receiving telemetry data generated by a telemetry data source, filter, by the filtering component, the received telemetry data based on the CEL filter program to generate filtered telemetry data.

16. The non-transitory computer-readable medium of claim 15, wherein to convert the telemetry filter definition into the CEL AST, the processing device is to:
parse the telemetry filter definition to generate an AST;
transpile the AST into CEL text; and
generate, based on the CEL text, the CEL AST.

17. The non-transitory computer-readable medium of claim 16, wherein the AST comprises a set of AST nodes and the transpiler maintains a mapping of each AST node to corresponding CEL text, and wherein to transpile the AST into the CEL text, the processing device is to:
use the mapping to identify the corresponding CEL text for each AST node of the AST.

18. The non-transitory computer-readable medium of claim 17, wherein the rules for routing and filtering telemetry data comprises rules for filtering telemetry data based on one or more of: resources that generated a plurality of events within the telemetry data, scopes of each of the plurality of events or values of each of the plurality of events.

19. The non-transitory computer-readable medium of claim 18, wherein to filter the received telemetry data, the processing device is to:
determine that the CEL filter program includes a rule for filtering the received telemetry data based on resources that generated a plurality of events within the received telemetry data; and
filter the received telemetry data using the rule before performing a flattening operation on the received telemetry data.

20. The non-transitory computer-readable medium of claim 19, wherein to filter the received telemetry data, the processing device is further to:
determine that the CEL filter program includes a second rule for filtering the received telemetry data based on scopes of each of the plurality of events within the received telemetry data; and
after performing the flattening operation on the received telemetry data, further filter the received telemetry data using the second rule to generate the filtered telemetry data.

21. The non-transitory computer-readable medium of claim 15, wherein the processing device is further to:
route the filtered telemetry data to one or more destinations based on the CEL filter program.
